(19) United States
(12) Patent Application Publication
(10) Pub. No.: US 2010/0065023 A1
(43) Pub. Date: Mar. 18, 2010

(54) Anti-Clogging Fuel Pump Module

(75) Inventors: William L. Villaire, Clarkston, MI (US); Robert Halsall, Washington, MI (US); Mitchell E. Hart, Grand Blanc, MI (US)

Correspondence Address: Keefe and Associates, 24405 Gratiot Avenue, Eastpointe, MI, 48021, US

(73) Assignee: GM GLOBAL TECHNOLOGY OPERATIONS, INC., DETROIT, MI (US)

(21) Appl. No.: 12/210,234

(22) Filed: Sep. 15, 2008

(51) Int. Cl. F02M 37/00

(52) U.S. Cl. 123/514

(57) ABSTRACT

A by-pass fuel system in which the plumbing of the fuel pump module is configured to ensure by-pass strained (and filtered) fuel remains separate from the reservoir fuel after by-pass such that it is not re-strained before re-entry to the fuel pump. The anti-clogging fuel pump module is plumbed such that the by-pass strained fuel is directed to the fuel pump separately with respect to the reservoir fuel, wherein it never mixes with reservoir fuel except after the reservoir fuel has passed through the strainer. Thus, the by-pass strained fuel only mixes with strained fuel from the strainer before its entry to the fuel pump. Accordingly, only reservoir fuel in the fuel pump module is passed through the strainer, whereby the clogging rate of the strainer is minimized.

### TECHNICAL FIELD

The present invention relates to fuel pump modules which are interfaced with fuel tanks for motor vehicles, and more particularly to a by-pass fuel system in which strained (and filtered) by-pass fuel is sent directly to the fuel pump without being re-strained.

### BACKGROUND OF THE INVENTION

Motor vehicle fuel tanks provide not only a reservoir for fuel but also must have accommodation for adding fuel, delivering fuel (i.e., to the engine) and monitoring the amount of the fuel therein. It has become a common practice to combine the fuel delivery and monitoring functions via a fuel pump module which is removably interfaced with an opening of the fuel tank outershell.

FIG. 1 depicts an example of a motor vehicle fuel tank 10 having, by way of example, a saddle shape featuring two fuel sumps 10a, 10b. The fuel tank outershell 12 is provided with first and second openings 12a, 12b, each opening being disposed over a respective fuel sump 10a, 10b. At the first sump 10a, and interfaced sealingly with the first opening 12a, is a fuel pump module 14, and at the second sump 10b and interfaced sealingly with the second opening 12b is a secondary fuel transfer source 16 which is fluidically connected to the fuel pump module 14 via a transfer line 18.

The fuel pump module 14 is part of a by-pass fuel system. With respect to by-pass fuel systems, there are feed and by-pass fuel lines which loop the fuel back to the fuel pump module or loop the fuel within the fuel pump module. The term “by-pass fuel system” refers to both “return fuel systems” and “mechanical returnless fuel systems”. In the case of returnless fuel systems, a fuel pressure regulator is included with the by-pass fuel loop, being located within the fuel pump module.

FIG. 2 depicts a schematic representation of the functional aspects of a fuel pump module 20 utilized in the prior art, as for example in the manner of fuel pump module 14 in FIG. 1 with respect to a fuel tank of a return fuel system. A module reservoir 22 is defined by a plastic module sidewall 20a. A fuel pump 24 draws reservoir fuel F_{R} through a strainer 26 in the module reservoir, and the strained fuel F_{S} is then pumped by the fuel pump 24, and the strained pumped fuel F_{P} is then delivered to the engine 40 via an inline fuel filter 28 and feed fuel line 30.

The by-pass fuel system continuously pumps fuel, and any amount not utilized by the engine is returned as a by-pass strained fuel F_{B} to the fuel pump module 20 by an intersecting by-pass fuel line 32 with a fuel pressure regulator 34 located between the fuel pump 24 and the engine 40. The by-pass strained fuel F_{B} is dumped via a standpipe 36 into the module reservoir 22. In this regard, because the by-pass strained fuel F_{B} dumpingly mixes with the reservoir fuel F_{R} already in the module reservoir, it becomes no longer separate as a uniquely identifiable entity and becomes merely a mixed aspect of the reservoir fuel F_{R} component, wherein all of the reservoir fuel must be strained before entry to the fuel pump.

In that a conventional fuel pump module of a by-pass fuel system dumps and mixes the by-pass strained fuel F_{B} with the reservoir fuel F_{R}, all fuel entering into the fuel pump must be strained in order to remove any contaminants from the fuel regardless of the fact that some of the fuel may have been previously strained. This requirement to strain all fuel entering the fuel pump irrespective of past strain history of the fuel requires the fuel pump to work harder than it might otherwise have to if somehow the strained fuel could remain separate. Further, the mixing of the by-pass strained fuel F_{B} with the reservoir fuel F_{R} causes the strainer to pass therethrough more fuel, with attendant clogging aspects, than would otherwise be necessary if somehow the strained fuel could remain separated from the reservoir fuel and somehow be able to pass to the fuel pump without being re-strained.

Accordingly, it would be desirable for by-pass fuel systems if somehow the by-pass strained fuel could remain separate from the reservoir fuel after by-pass such that it would not have to be re-strained before entry to the fuel pump.

### SUMMARY OF THE INVENTION

The present invention is a by-pass fuel system in which the plumbing of the fuel pump module is configured such that the by-pass strained fuel remains separate from the reservoir fuel after by-pass such that it is not re-strained before re-entry to the fuel pump.

The anti-clogging fuel pump module according to the present invention is plumbed to ensure the by-pass strained (and filtered) fuel is directed to the fuel pump separately with respect to the reservoir fuel, wherein it never mixes with reservoir fuel except after the reservoir fuel has passed through the strainer. Thus, the by-pass strained fuel only mixes with strained fuel from the strainer before its entry to the fuel pump. Accordingly, only reservoir fuel in the fuel pump module is passed through the strainer, whereby the clogging rate of the strainer is minimized.

A benefit of the anti-clogging fuel pump module is that it allows the fuel pump to preferentially utilize the by-pass strained fuel, thereby reducing the relative flow rate of the fuel pump reservoir fuel (unstrained fuel) through the strainer attached to the fuel pump. This reduction in the reservoir fuel (unstrained and potentially “dirty” fuel) flow through the strainer will reduce the capture of fine sediment particles in and on the strainer, wherein such particles tend to clog the strainer. Other benefits of the present invention include a potential cleaning effect of the outer surface of the strainer by flow of the by-pass strained fuel, a potential reduction of fuel pump wear, an improvement in the hot fuel handling capabilities of the fuel pump by increasing the fuel pressure (reducing fuel vapor formation in the fuel pump) at the inlet of the pump, and reduction of the volatility of the fuel due to direct recirculation of strained fuel and vapor stripping of the fuel being pumped.

Accordingly, it is an object of the present invention to provide a by-pass fuel system in which the plumbing of the fuel pump module is configured such that the by-pass strained fuel remains separate from the reservoir fuel after by-pass such that it is not re-strained before re-entry to the fuel pump.

This and additional objects, features and advantages of the present invention will become clearer from the following specification of a preferred embodiment.

### BRIEF DESCRIPTION OF THE DRAWINGS

FIG. 1 is a perspective view of a fuel tank, showing in particular a fuel pump module interfaced therewith.

FIG. 2 is a schematic representation of a prior art fuel pump module for a fuel tank of a by-pass fuel system.

FIG. 3A is a schematic representation of a first example of a preferred embodiment of the anti-clogging fuel pump module for a fuel tank of a by-pass fuel system according to the present invention.

FIG. 3B is a schematic representation of a second example of the preferred embodiment of the anti-clogging fuel pump module for a fuel tank of a by-pass fuel system according to the present invention.

FIG. 3C is a schematic representation of a third example of the preferred embodiment of the anti-clogging fuel pump module for a fuel tank of a by-pass fuel system according to the present invention.

FIG. 3D is a schematic representation of a fourth example of the preferred embodiment of the anti-clogging fuel pump module for a fuel tank of a by-pass fuel system according to the present invention.

FIG. 4 is a partly sectional side view of an implementation of the preferred embodiment of the anti-clogging fuel pump module for a fuel tank of a by-pass fuel system according to the present invention.

FIG. 5 is an exploded view of the anti-clogging fuel pump module of FIG. 4.

### DESCRIPTION OF THE PREFERRED EMBODIMENT

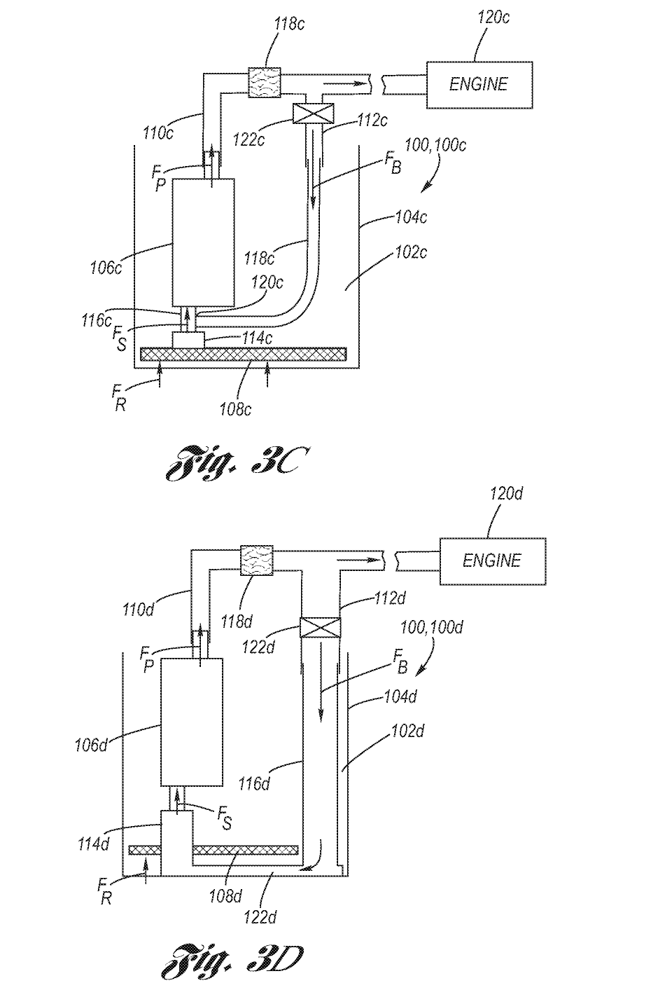

Referring now to the Drawing, FIGS. 3A through 5 depict various aspects of an anti-clogging fuel pump module 100 for a fuel tank of a by-pass fuel system, wherein the by-pass strained fuel remains separate from the reservoir fuel (i.e., it retains its unique identity) after by-pass such that it is not mixed with the reservoir fuel upstream of the strainer, but rather mixed with strained fuel downstream of the strainer before delivery to (i.e., upstream of) the fuel pump.

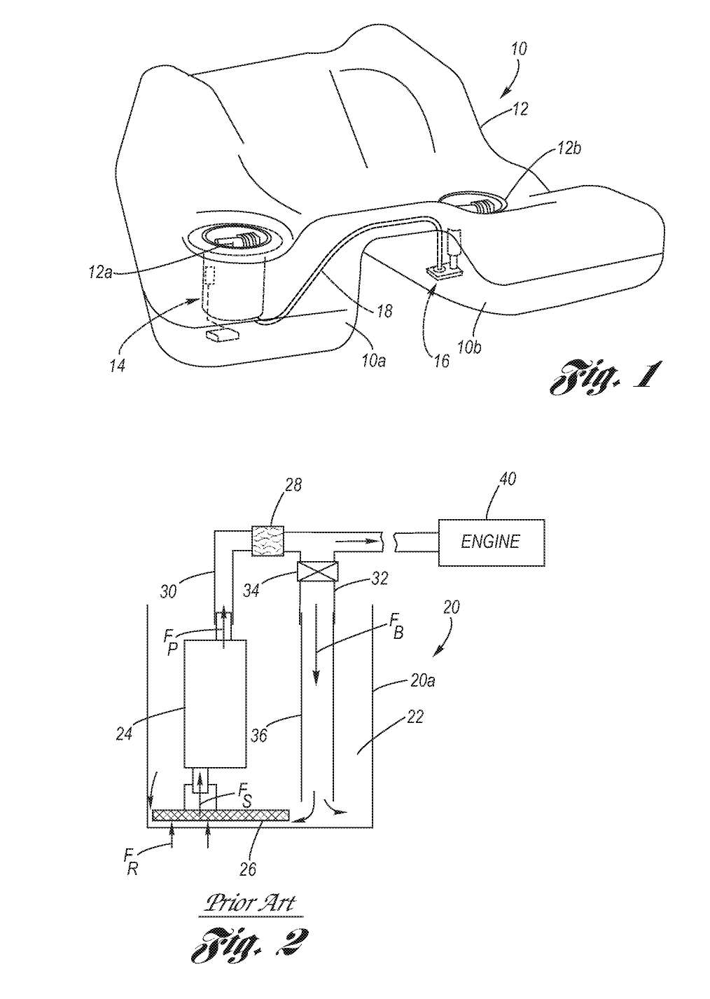

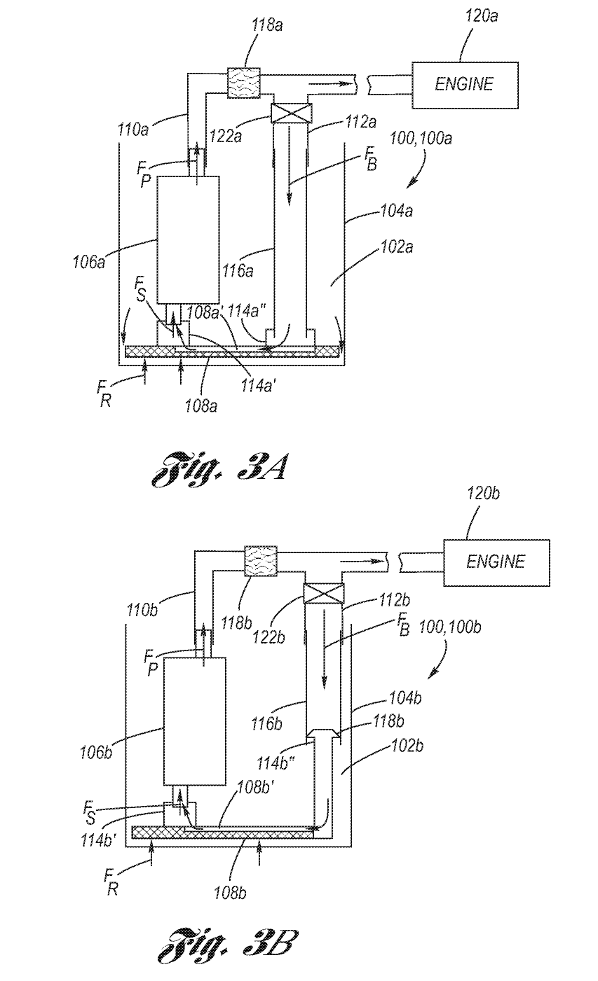

Referring now to FIG. 3A, a first schematic example of the anti-clogging fuel pump module 100, 100a is depicted, utilized as for example in the manner of fuel pump module 14 in FIG. 1 with respect to a fuel tank of a by-pass fuel system.

The fuel pump module 100a has a module reservoir 102a defined by a plastic module sidewall 104a. Strained fuel F_{S} which has passed through a strainer 108a is pumped by a fuel pump 106a, and delivered as strained pumped fuel F_{P} to the engine 120a via an in-line fuel filter 118a and feed fuel line 110a, wherein strained pumped fuel not utilized by the engine is by-passed, via an intersecting by-pass fuel line 112a with a fuel pressure regulator 122a located between the fuel pump 106a and the engine 120a, as by-pass return strained fuel F_{B}.

The strainer 108a has two ports, a first port 114a′ for delivery of strained fuel F_{S} to the fuel pump 106a, and a second port 114a″ which communicates with a standpipe 116a which is, in turn, connected to the by-pass fuel line 112a. The second port communication is plumbed so as to be exclusive with respect to the by-pass strained fuel F_{B} (i.e., there is no communication with the reservoir fuel F_{R}). Strained pumped fuel F_{P} not used by the engine is by-passed, through the by-pass fuel line 112a and the pressure regulator 122a, into the standpipe 116a and then into an internal channel 108a′ of the strainer 108a, whereby the by-pass strained fuel F_{B} is directly recirculated into the fuel pump 106a. Reservoir (bulk) fuel F_{R} is also drawn into the strainer 108a to augment the fuel flow requirement of the engine. All the components are contained within the fuel pump module reservoir 102a with the possible exception of the pressure regulator which may be located remotely in the vehicle architecture.

Referring now to FIG. 3B, a second schematic example of the anti-clogging fuel pump module 100, 100b is depicted, utilized as for example in the manner of fuel pump module 14 in FIG. 1 with respect to a fuel tank of a by-pass fuel system.

The fuel pump module 100b has a module reservoir 102b defined by a plastic module sidewall 104b. Strained fuel F_{S} which has passed through a strainer 108b is pumped by a fuel pump 106b, and delivered as strained pumped fuel F_{P} to the engine 120b via an in-line fuel filter 118b and feed fuel line 110b, wherein strained pumped fuel not utilized by the engine is by-passed, via an intersecting by-pass fuel line 112b with fuel pressure regulator 122b located between the fuel pump 106b and the engine 120b, as by-pass return strained fuel F_{B}.

The strainer 108b has two ports, a first port 114b′ for delivery of strained fuel F_{S} to the fuel pump 106b, and a second port 114b″ which communicates with a standpipe 116b which is, in turn, connected to the by-pass fuel line 112b. The second port communication is plumbed so as to be exclusive with respect to the by-pass strained fuel F_{B} (i.e., there is no communication with the reservoir fuel F_{R}). Strained pumped fuel F_{P} not used by the engine is by-passed, through the by-pass fuel line 112b and the fuel pressure regulator 122b, into the standpipe 116b and then into a strained-fuel-side internal channel 108b′ of the strainer 108b, whereby the by-pass strained fuel F_{B} is directly recirculated into the fuel pump 106b. Reservoir (bulk) fuel F_{R} is also drawn into the strainer 108b to augment the fuel flow requirement of the engine.

The fuel pump module 100b differs from the fuel pump module 100a in that the second port 114b″ is inserted sealingly by a seal 118b into the standpipe 116b, thereby allowing the by-pass fuel flow to be directed along the entire internal channel 108b′ of the strainer 108b, wherein the strainer is also completely contained within the module reservoir.

Referring now to FIG. 3C, a third schematic example of the anti-clogging fuel pump module 100, 100c is depicted, utilized as for example in the manner of fuel pump module 14 in FIG. 1 with respect to a fuel tank of a by-pass fuel system.

The fuel pump module 100c has a module reservoir 102c defined by a plastic module sidewall 104c. Strained fuel F_{S} which has passed through a strainer 108c is pumped by a fuel pump 106c, and delivered as strained pumped fuel F_{P} to the engine 120c via an inline fuel filter 122c and feed fuel line 110c, wherein strained pumped fuel not utilized by the engine is by-passed, via an intersecting by-pass fuel line 112c with a fuel pressure regulator 122c located between the fuel pump 106c and the engine 120c, as by-pass strained fuel F_{B}.

The strainer 108c has a single port 114c for delivery of strained fuel F_{S} to the fuel pump 106c via a fitting 116c. In the fuel pump module 100c, rather than a standpipe, a by-pass tube 118c, which may be flexible or rigid, directly connects to the fitting 116c downstream of the strainer 108c and upstream of the fuel pump 106c, via a side port 120c, wherein there is no communication with the reservoir fuel F_{R}. Strained pumped fuel F_{P} not used by the engine is by-passed, through the by-pass fuel line 112c and the fuel pressure regulator 122c, into the by-pass tube to the fuel pump 106c, whereby the by-pass strained return fuel F_{B} is directly recirculated into the fuel pump. Reservoir (bulk) fuel F_{R} is also drawn into the strainer 108c to augment the fuel flow requirement of the engine, wherein the strainer is also completely contained within the module reservoir.

Referring now to FIG. 3D, a fourth schematic example of the anti-clogging fuel pump module 100, 100d is depicted, utilized as for example in the manner of fuel pump module 14 in FIG. 1 with respect to a fuel tank of a by-pass fuel system.

The fuel pump module 100d has a module reservoir 102d defined by a plastic module sidewall 104d. Strained fuel F_{S} which has passed through a strainer 108d is pumped by a fuel pump 106d, and delivered as strained pumped fuel F_{P} to the engine 120d via an in-line fuel filter 122d and feed fuel line 110d, wherein strained pumped fuel not utilized by the engine is by-passed, via an intersecting by-pass fuel line 112d with fuel pressure regulator 122d located between the fuel pump 106d and the engine 120d, as by-pass strained fuel F_{B}.

The strainer 108d communicates with a strainer fitting 114d through which is provided delivery of strained fuel F_{S} to the fuel pump 106d. In the fuel pump module 100d, a standpipe 116d connects to the by-pass fuel line 110d and an external channel 122d. The external channel 122d, in turn, connects to the strainer fitting 114d. Strained pumped fuel F_{P} not used by the engine is by-passed through the by-pass fuel line 112d and fuel pressure regulator 122d into the strainer fitting 114d to the fuel pump 106d, whereby the by-pass strained fuel F_{B} is directly recirculated into the fuel pump. Reservoir (bulk) fuel F_{R} is also drawn into the strainer 108d and then into the strainer fitting to augment the fuel flow requirement of the engine, wherein the strainer is also completely contained within the module reservoir, and wherein the strainer is also completely contained within the module reservoir.

In the examples of FIGS. 3A through 3D, heat transfer plumbing, or a heat exchanger may be provided in the module reservoir as needed according to standard practices in the art in order to eliminate fuel heating and/or aging effects.

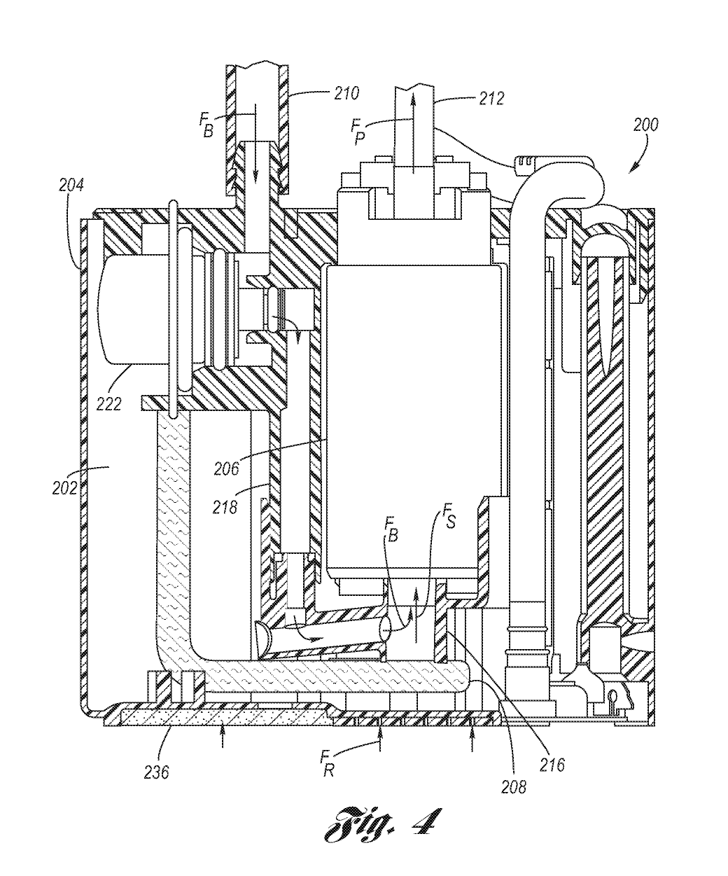

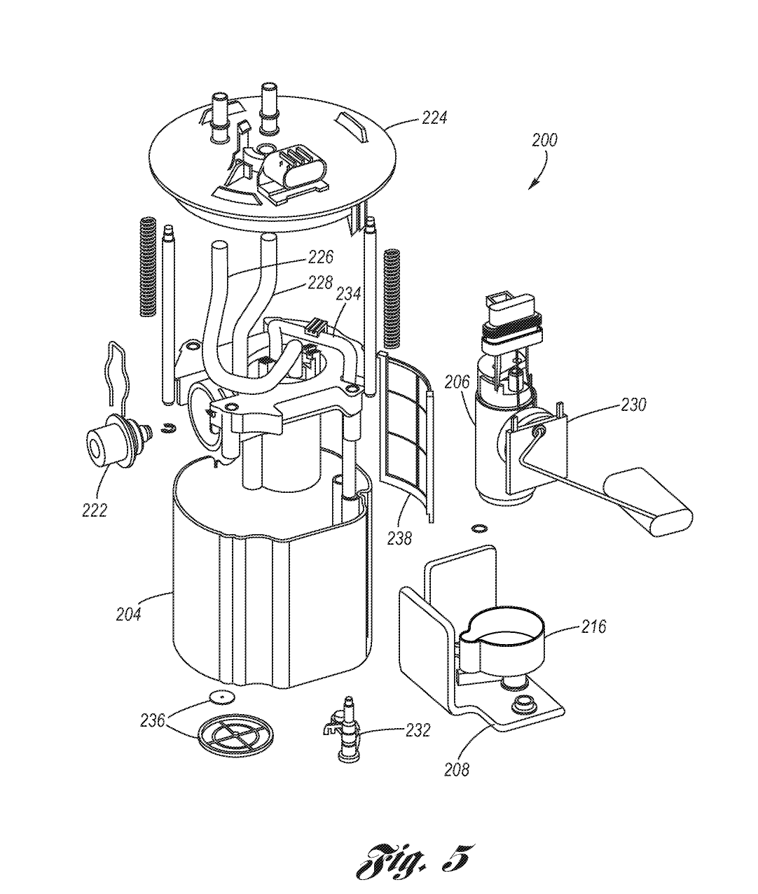

Turning attention now to FIGS. 4 and 5, an anti-clogging fuel pump module 200 is depicted, which is an implementation of the anti-clogging fuel pump module 100c of FIG. 3C.

The fuel pump module 200 has a module reservoir 202 defined by a plastic module sidewall 204. Strained fuel F_{S} which has passed through a strainer 208 is pumped by a fuel pump 206, and delivered as strained pumped fuel F_{P} to the engine via a feed fuel line 210 and in-line filter (not shown), wherein strained pumped fuel not utilized by the engine is by-passed, via an intersecting by-pass fuel line 212 located between the fuel pump 206 and the engine (not shown), as by-pass strained fuel F_{B}.

The strainer 208 delivers strained fuel F_{S} to the fuel pump 206 via a strainer cup 216. A by-pass tube 218, which is in this case is rigid, directly connects to the strainer cup 216 downstream of the strainer 208 and upstream of the fuel pump 206, wherein there is no communication with the reservoir fuel F_{R}. Strained pumped fuel F_{P} not used by the engine is by-passed, via a pressure regulator 222, through the by-pass tube 218 to the fuel pump 206, whereby the by-pass strained fuel F_{B} is directly recirculated into the fuel pump. Reservoir (bulk) fuel F_{R} is also drawn into the strainer 208 to augment the fuel flow requirement of the engine, wherein the strainer is also completely contained within the module reservoir.

As shown at FIG. 5, which is an exploded view of FIG. 4, additional parts include: a flange assembly 224, a delivery hose 226, a return hose 228, a float-type fuel level sensor assembly 230, a supply jet assembly 232, a supply jet hose 234, a protector strainer and check valve 236 of the strainer, and a reservoir protector strainer 238.

To those skilled in the art to which this invention appertains, the above described preferred embodiment may be subject to change or modification. Such change or modification can be carried out without departing from the scope of the invention, which is intended to be limited only by the scope of the appended claims.

1. A fuel pump module for a by-pass fuel system, comprising:
a module reservoir;
a fuel pump disposed in said module reservoir;
a strainer connected to said fuel pump; and
by-pass fuel plumbing connected to said fuel pump;
wherein fuel is flowingly pumped in response to pumping by said fuel pump, wherein said connections are both disposed downstream of the strainer and upstream of the fuel pump as defined by the flow of the fuel.

2. The fuel pump module of claim 1, wherein said strainer has a first port and a second port, said first port being connected to said fuel pump; wherein said by-pass fuel plumbing comprises:
a standpipe connected to said second port; and
a channel disposed internally with respect to said strainer, said channel extending between said first and second ports, said channel being disposed downstream of said strainer and upstream of said fuel pump.

3. The fuel pump module of claim 1, wherein said strainer has a first port and a second port, said first port being connected to said fuel pump; wherein said by-pass fuel plumbing comprises:
a standpipe connected to said second port; and
a channel disposed internally with respect to said strainer, said channel extending between said first and second ports, said channel being disposed downstream of said strainer and upstream of said fuel pump;
wherein said second port is sealingly disposed within said standpipe.

4. The fuel pump module of claim 1, wherein said strainer has a port connected to said fuel pump; wherein said by-pass fuel plumbing comprises:
a fitting connected to said fuel pump upstream of said fuel pump and downstream of said strainer, said port being connected to said fitting; and
a tube connected to said fitting.

5. The fuel pump module of claim 1, wherein said strainer has a port connected to said fuel pump; wherein said by-pass fuel plumbing comprises:
a standpipe;
a channel disposed externally with respect to said strainer, said channel being connected to said standpipe; and
a fitting connected to said fuel pump upstream of said fuel pump and downstream of said strainer, wherein said port is connected to said fitting downstream of said strainer, and wherein said channel is connected to said fitting downstream of said strainer.

6. A by-pass fuel system, comprising:
a module reservoir;
a fuel pump disposed in said module reservoir;
a feed fuel line connected to said fuel pump downstream of said fuel pump;
a by-pass fuel line intersecting said feed fuel line;
a strainer connected to said fuel pump upstream of said fuel pump; and
by-pass fuel plumbing connected to said return fuel line and connected to said fuel pump upstream of said fuel pump and downstream of said strainer;
wherein fuel is flowingly pumped in response to pumping by said fuel pump, and wherein downstream and upstream are defined by the flow of the fuel.

7. The by-pass fuel system of claim 6, wherein said strainer has a first port and a second port, said first port being connected to said fuel pump; wherein said by-pass fuel plumbing comprises:
a standpipe connected to said second port and to said by-pass fuel line; and
a channel disposed internally with respect to said strainer, said channel extending between said first and second ports, said channel being disposed downstream of said strainer and upstream of said fuel pump.

8. The by-pass fuel system of claim 6, wherein said strainer has a first port and a second port, said first port being connected to said fuel pump; wherein said by-pass return fuel plumbing comprises:
a standpipe connected to said second port and to said by-pass fuel line; and
a channel disposed internally with respect to said strainer, said channel extending between said first and second ports, said channel being disposed downstream of said strainer and upstream of said fuel pump;
wherein said second port is sealingly disposed within said standpipe.

9. The by-pass fuel system of claim 6, wherein said strainer has a port connected to said fuel pump; wherein by-pass fuel plumbing comprises:
a fitting connected to said fuel pump upstream of said fuel pump and downstream of said strainer, said port being connected to said fitting; and
a tube connected to said fitting and said return fuel line.

10. The by-pass fuel system of claim 6, wherein said strainer has a port connected to said fuel pump; wherein said by-pass fuel plumbing comprises:
a standpipe connected to said by-pass fuel line;
a channel disposed externally with respect to said strainer, said channel being connected to said standpipe; and
a fitting connected to said fuel pump upstream of said fuel pump and downstream of said strainer, wherein said port is connected to said fitting downstream of said strainer, and wherein said channel is connected to said fitting downstream of said strainer.

11. A method for pumping fuel of a by-pass fuel system, comprising the steps of:
pumping strained fuel to an engine;
by-passing the pumped strained fuel not needed by the engine as by-pass strained fuel;
straining fuel of a fuel reservoir to provide strained reservoir fuel; and
delivering the by-pass strained fuel and the strained reservoir fuel to the fuel pump for pumping thereby to the engine, wherein the return strained fuel mixes with only strained reservoir fuel.

12. The method of claim 11, wherein in said step of delivering, the by-pass strained fuel avoids said step of straining.
